(19) United States
(12) Patent Application Publication
(10) Pub. No.: US 2020/0082289 A1
(43) Pub. Date: Mar. 12, 2020

(54) TASK SCHEDULING RECOMMENDATIONS FOR REDUCED CARBON FOOTPRINT

(71) Applicant: Microsoft Technology Licensing, LLC, Redmond, WA (US)

(72) Inventors: Stanislaw Wiktor Swierc, Redmond, WA (US); Conor E. Kelly, Bothell, WA (US); Om Prakash Ravi, Sammamish, WA (US); Supradha Sankaran, Redmond, WA (US)

(21) Appl. No.: 16/172,142

(22) Filed: Oct. 26, 2018

Related U.S. Application Data
(60) Provisional application No. 62/729,867, filed on Sep. 11, 2018.

(51) Int. Cl. G06N 5/04; G06N 7/00; H02J 3/14

(52) U.S. Cl. CPC G06N 5/048; G06N 7/005; H02J 2003/007; H02J 2003/143; H02J 3/14

(57) ABSTRACT

A method for generating scheduling recommendations for energy consumption tasks includes determining an estimated time-variant quantity of carbon emissions released from an energy supply plant over a future time interval; predicting a probability of user compliance with a recommendation to initiate an energy consumption task at one or more times within the future time interval; selecting a recommended start time for the energy consumption task based on both the predicted time-variant quantity of carbon emissions and the predicted probability of user compliance with the recommendation at the recommended start time; and outputting the recommended start time.

### CROSS-REFERENCE TO RELATED APPLICATIONS

This application claims priority to provisional patent application No. 62/729,867, titled Task Scheduling Recommendations for Reduced Carbon Footprint, filed on Sep. 11, 2018, which is hereby incorporated by reference for all that it discloses or teaches.

### BACKGROUND

Modern power distribution grids consist of power drawn from a variety of energy sources including renewable sources (e.g., solar, wind) and non-renewable sources (e.g., “dirty” sources such as fossil fuels). Throughout the day, there exist times when renewable energy resources make up a larger percentage of the power consumed from a power grid. At any given time, the percentage of the grid supported by renewable resources may depend on both user demand and the available supply of those renewable energy resources, both of which may vary throughout the day. For example, user demand may rise during business hours when businesses are open and the supply of renewable energy resources may dwindle at certain times as a result of low-sun or low-wind weather patterns.

### BRIEF DESCRIPTIONS OF THE DRAWINGS

FIG. 1 illustrates an example system that generates recommendations for scheduling energy consumption tasks that may help a user reduce the carbon footprint attributable to those tasks.

FIG. 2 illustrates aspects of another system that generates recommendations for scheduling energy consumption tasks at times during the day when a local energy grid has a greater dependence on renewable resources and when a user is likely to comply with such recommendations.

FIG. 3 illustrates another example system that generates recommendations for scheduling energy consumption tasks that may help a user reduce the carbon footprint attributable to those tasks.

FIG. 4 illustrates example operations for rendering a recommendation to schedule an energy consumption task is likely to be adopted by a user and likely to reduce the associated carbon footprint.

FIG. 5 illustrates an example schematic of a processing device suitable for implementing aspects of the disclosed technology.

### SUMMARY

A method includes determining an estimated time-variant quantity of carbon emissions released from an energy supply plant over a future time interval; predicting a probability of user compliance with a recommendation to initiate an energy consumption task at one or more times within the future time interval; selecting a recommended start time for the energy consumption task based on both the predicted time-variant quantity of carbon emissions and the predicted probability of user compliance with the recommendation at the recommended start time; and outputting the recommended start time for the energy consumption task.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### Description

Many individuals would, if given the option, choose to reduce the carbon footprint of their everyday tasks by running home appliances as times when renewable energy sources represent a larger fraction of the power grid supplying energy to their homes. However, current resources do not provide users with an easy mode of access to power grid information. Moreover, a user's decision to schedule an appliance task may depend on other factors in addition to carbon-emission concerns. For example, a user may not want to run a noisy dryer at night or run the dishwasher late in the afternoon when the dishes may not have time to dry before the user returns home from work. This myriad of considerations complicates efforts to auto-configure smart appliances and/or provide tools simple enough to be adopted into the home that are also capable of providing meaningful recommendations that a user is likely to adopt.

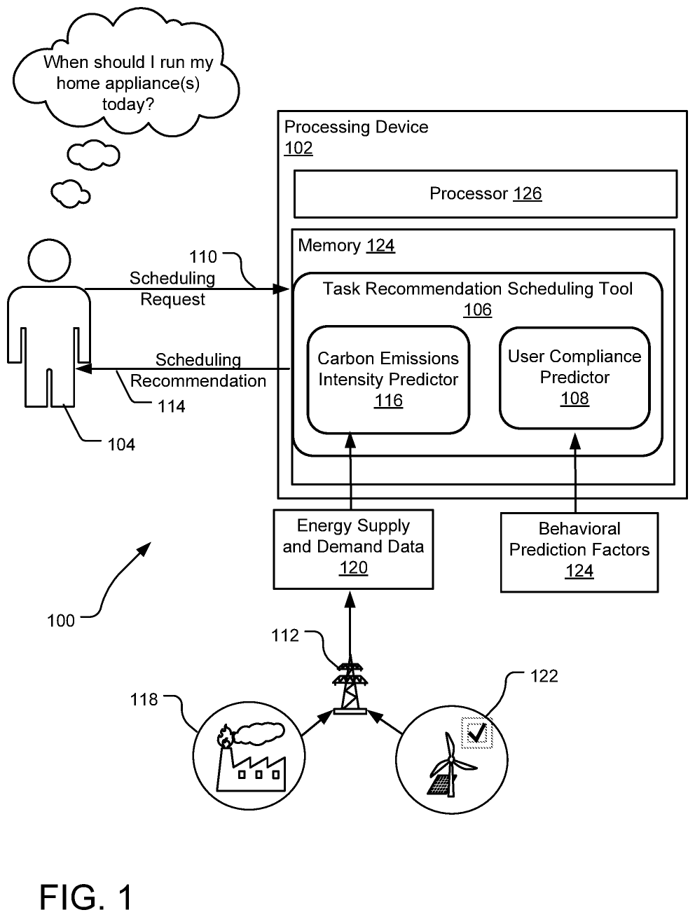

FIG. 1 illustrates an example system 100 that generates recommendations for scheduling energy consumption tasks that may, if executed in accord with the recommendations, help a user reduce the carbon footprint attributable to those energy consumption tasks. The system 100 is shown to include a processing device 102 with a processor 126 and memory 124 storing a task scheduling recommendation tool 106. Although the disclosed technology may be implemented for scheduling many different types of energy-consumption tasks in different settings (home, office, industrial, etc.), the examples herein presented describe uses of the task scheduling recommendation tool 106 that pertain to the scheduling of home-based energy consumption tasks that are typically user-initiated such as starting a washer, dryer, dishwasher, etc.

In one implementation, the processing device 102 is a personal mobile device such as a smart phone or laptop. The user interacts with the processing device 102 to provide inputs to and receive scheduling recommendations from the task scheduling recommendation tool 106. For example, the task scheduling recommendation tool 106 may be a mobile application. In another implementation, the processing device 102 is integrated within an electronic voice assistant that communicates a web-based solution (not shown) to process and render verbal responses to user speech. For example, the task scheduling recommendation tool 106 may be an application or application plug-in that supports functionality for a home voice assistant (e.g., Microsoft's Cortana,® Amazon's Alexa®, Google Home,® Apple's Siri®).

In still another implementation, the task scheduling recommendation tool 106 is integrated into or otherwise in communication with one or more home-based smart devices. Rather than provide scheduling recommendations to a user 104 (e.g., as shown in FIG. 1 and generally described below), the task scheduling recommendation tool 106 may instead provide recommendations to a smart appliance. For example, a smart appliance may communicate with the task scheduling recommendation tool 106 to self-schedule tasks without user input and/or to determine a recommended scheduling time and present the user with the recommendation, such as on a display of a smart appliance (e.g., an oven, dishwasher, dryer).

The task scheduling recommendation tool 106 includes logic designed to reconcile the scheduling needs and preferences of a user (e.g., the user 104) with the user's desire to execute home-based energy-consumption tasks at times that effectively reduce the carbon emissions released into the atmosphere as a result of those tasks. In FIG. 1, the task scheduling recommendation tool 106 includes two prediction modules—a carbon emissions intensity predictor 116 and a user compliance predictor 108. In general, these modules perform tasks for retrieving, generating, and/or outputting predictive information that is aggregated together and utilized as a basis for selecting one or more times for initiating an energy consumption task identified by a scheduling request 110, such as a user-initiated request pertaining to a home-based appliance task.

At different times during the day, a local energy supply grid 112 may be supported by a different ratio of non-renewable resources 118 (e.g., fossil fuels) to renewable resources 122 (e.g., solar, wind). Since renewable resources 122 are less expensive than non-renewable resources 118, energy supply companies may try to support as much of the local energy supply grid 112 as possible with available renewable resources. At any given time, an energy supply company may use non-renewable (dirty) resources to support the quantity of the energy demand exceeding the available renewable energy supply. Since renewable energy supplies are higher at certain times of day, as when sun and wind conditions are favorable, the observed carbon emissions intensity per unit of energy (kgCO₂/kWh) may decrease when energy demand is lower and also when the availability of renewable resources is higher. At these times, execution of an energy consumption task effectively contributes a smaller quantity of carbon emissions to the atmosphere than execution of the same task at times when a larger fraction of the local energy supply grid 112 is supported by non-renewable (dirty) resources.

In one implementation, the carbon emissions intensity predictor 116 utilizes energy supply and demand data 120, such as history energy usage trends and renewable energy supply predictions, to predict a time-variant estimated quantity of carbon emissions released from the local energy supply grid 112. In the same or another implementation, the user compliance predictor 108 predicts a probability of user compliance with a scheduling recommendation to initiate the energy consumption task one or more times throughout the future time interval. The task scheduling recommendation tool 106 selects a recommended start time for the energy consumption tank based on both the predicted carbon emissions and the predicted probability of user compliance at various times throughout the future interval.

As used herein, “user compliance” may refer to either active compliance (e.g., compliance achieved via user action, such as initiating a task at a recommended time or programming the appliance to self-execute at that time) or passive compliance (e.g., compliance achieved via lack of action, such as by allowing an appliance to self-schedule a task at the recommended time and execute the task without interrupt due to user intervention).

In FIG. 1, inputs to the user compliance predictor 108 are collectively represented as behavioral prediction factors 124. The behavioral prediction factors 124 may include factors such as individual user preferences (e.g., user-designated preferences or machine-inferred user preferences), appliance data (e.g., task duration, energy demand), global community data (e.g., trends in user preferences), and/or other factors that may indicate whether or not the user 104 is likely to implement and energy-consumption recommendation at a given time

In one implementation, the behavioral prediction factors 124 provide the user compliance predictor 108 with information for determining a user's schedule and/or the user's preferences associated with execution of different types of tasks. For example, a user may choose to program a dishwasher to start at an early enough time to ensure that the dishes are washed and dried before the user arrives home from work. Similarly, a user working a night shift job may have the same preference (e.g., dishes done upon arrival home from work) but on an opposite time schedule (nighttime execution instead of day time execution).

In another implementation, the behavioral prediction factors 124 provide the user compliance predictor 108 with information about a particular type of appliance that is to be executing the energy consumption task. For example, the behavior prediction factors may include the make or model of the appliance and/or other information usable to determine or estimate information such as the run-time of a particular task, the wattage of the appliance, etc. If the make and model indicate that the appliance is non-programmable, the user compliance predictor 108 may be able to correctly infer that there exists a low likelihood of user compliance with a recommendation to start the appliance at times when the user is not at home. In some implementation, the behavioral prediction factors 124 may also include user schedule data (either inferred or set by a user, such as through an electronic calendar program). Likewise, the behavioral prediction factors 124 may include information specifying or usable to infer user scheduling preferences, such as a preference to avoid scheduling a loud appliance to execute at certain times, such as at night or during the day when the user routinely avoids running appliances (e.g., because the baby is napping or other personal reason).

Based on the predictive outputs from the user compliance predictor 108 and the carbon emissions intensity predictor 116, the task scheduling recommendation tool 106 identifies one or more recommended time-windows within a future interval for scheduling an energy consumption task and outputs a scheduling recommendation 114.

In the example illustrated of FIG. 1, the scheduling request 110 is made by a user 104. In one implementation where the task scheduling recommendation tool 106 is implemented in a home voice assistant, the user 104 may initiate the scheduling request 110 verbally, such as by asking a question (e.g., “is now a good time to run the dryer?” or “when a good time to run the dryer?”). In another implementation, the task scheduling recommendation tool 106 is a web-based tool and the user 104 provides the request 110 in the form of web-based inputs received through a keypad, mouse, touchscreen, or other input device.

In yet another implementation, the task scheduling recommendation tool 106 is implemented within firmware of a smart appliance. In this case, the user 104 may provide the request 110 by pressing a button on the appliance or otherwise providing input to the appliance. For example, the user 104 may press the start button on a clothes dryer to cause the task scheduling recommendation tool 106 to selects a time for starting the dryer.

In different implementations, the scheduling request 110 and the scheduling recommendation 114 may take on different forms. In FIG. 1 the task scheduling recommendation tool 106 is illustrated outputting a scheduling recommendation 114 to the user 104. In one implementation, the scheduling recommendation 114 is verbally conveyed (e.g., via a voice assistant saying “the best time to start the dryer today is 1:15pm”). In another implementation, the scheduling recommendation 114 is rendered on display. In still other implementations, the task scheduling recommendation tool 106 provides the scheduling recommendation 114 to a smart appliance rather than the user 104. For example, the smart appliance may self-schedule itself to begin the energy consumption task at a time specified by the scheduling recommendation 114 or the smart appliance may prompt a user (e.g., via a display) to accept the recommended time.

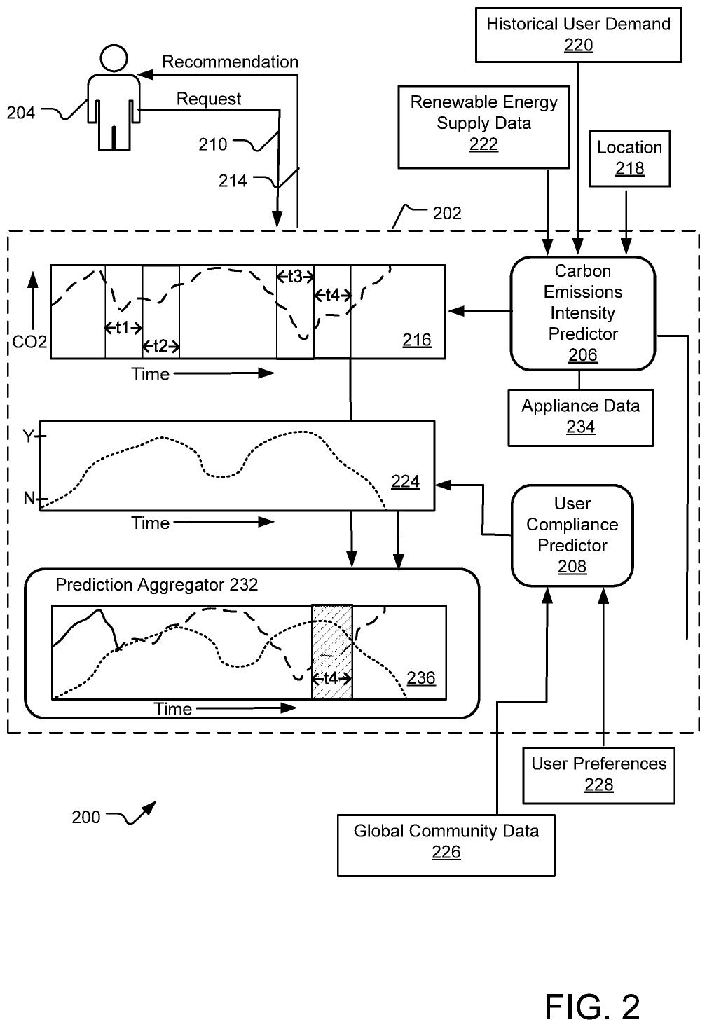

FIG. 2 illustrates aspects of another system 200 that generates recommendations for scheduling energy consumption tasks at times during the day when a local energy grid has a greater dependence on non-renewable resources and when a user is likely to comply with such recommendations. In the illustrated implementation, the task scheduling recommendation tool 202 receives a scheduling request 210 from a user 204. The scheduling request 210 identifies an energy consumption task (e.g., washing the dishes, washing clothes, drying clothes) and/or identifies a household appliance for executing the energy consumption task (e.g., a dishwasher, washing machine dryer). In some cases, the scheduling recommendation 214 identifies nature of the task (e.g., “when should I cook the turkey”) and the task scheduling recommendation tool 202 identifies the appliance to perform the task (e.g., an oven), such as by accessing a table of stored keyword associations. In still other implementations, the scheduling request 210 identifies a particular appliance (e.g., “when should I use the oven?”), and the task scheduling recommendation tool 202 infers the nature of the task (e.g., cooking) and/or other information used in rendering a scheduling recommendation 214 in response to the scheduling request 210..

In some implementations, the task scheduling recommendation tool 202 initially responds to the scheduling request 210 by requesting further information from the user such as the length of the task (“how long do you plan to cook the turkey?”) or by requesting information about the type of appliance being used if such information is not otherwise available to the task scheduling recommendation tool 202.

The task scheduling recommendation tool 202 includes a carbon emissions intensity predictor 206 and a user compliance predictor 208. In response to receipt of the scheduling request 210, each of the carbon emissions intensity predictor 206 and the user compliance predictor 208 determine predictions, such as via dynamic calculation or prediction look-up form a third-party source, that are used in rendering the scheduling recommendation 214 to the user 204.

In one implementation, the carbon emissions intensity predictor 206 predicts a time-variant quantity of carbon emissions (e.g., predicted emissions 216) that are to be released from an energy supply plant over a future time interval, such as the next 12 or 24 hours following initial receipt of the scheduling request 210. For example, the predicted emissions 216 may represent a forecast of carbon emissions intensity per unit of energy (kgCO₂/kWh) delivered by to the atmosphere over a future period of time by an identified power distribution grid. The identified power distribution grid is, for example, a grid that supplies energy to a location 218 associated with the scheduling request 210.

The carbon emissions intensity predictor 206 may retrieve the location 218 in different ways, such as via user input identifying a particular zip code, address, or other information sufficient to identify a power distribution grid that supplies energy to an appliance that is to be executing the energy consumption task identified by the scheduling request 210. In one implementation, the user 204 sets the location 218 during initialization of the task scheduling recommendation tool 202. In another implementation, the carbon emission intensity predictor 206 utilizes GPS information or location information provided by a local Wi-Fi access point.

Using the location 218, the carbon emissions intensity predictor 206 identifies the power distribution grid that supplies power to a service area including the location 218, such as by accessing a table (not shown) or database associating location service area information with identifying information for different power distribution grids. After identifying the power distribution grid supplying power to the location 218, the carbon emissions intensity predictor 206 retrieves renewable energy supply data 222 for the identified power distribution grid. For example, the carbon emissions intensity predictor 206 may initiate a query to one or more private or publicly accessible databases storing and maintaining the renewable energy supply data 222 for the identified power distribution grid. In one implementation, the renewable energy supply data 222 includes information that the carbon emissions intensity predictor 206 uses to forecast a supply of renewable energy sources available to the identified power grid over a future interval, such as the next 12 or 24 hours. For example, the renewable energy supply data 222 includes weather forecasts (e.g., solar, wind) retrieved from a weather forecasting model. In yet another implementation, the renewable energy supply data 222 includes a renewable energy supply forecast that is generated by a third party.

In addition to receiving renewable energy supply data 222 for the future time interval (e.g., the next 12 or 24 hours), the carbon emissions intensity predictor 206 may also receive historical user demand data 220 for the identified energy distribution grid. For example, the historical user demand data 220 may indicate a historical energy demand on the identified power distribution grid, such as at a date corresponding to the day of year and/or time of day of spanned by the future time interval associated with the request.

Using the historical user demand data 220 and the renewable energy supply data 222 for the location 218, the carbon emissions intensity predictor 206 generates the predicted emissions 216 over the future time interval for the energy distribution grid identified by the location 218. In another implementation, the carbon emission intensity predictor 206 retrieves (rather than generates) the predicted emissions 216 for the location 218. For example, the carbon emission intensity predictor 206 may query a third-party database for the predicted emissions 216 in response to receiving the scheduling request 210.

In FIG. 2, the carbon emissions intensity predictor 206 identifies time intervals, referred to herein as “candidate windows” (e.g., candidate windows t1, t2, t3, and t4) over which the predicted emissions 216 satisfy predefined low emissions criteria. For example, a candidate window may satisfy the predefined low emissions criteria when the predicted net CO2 emissions over the window are capped below a predetermined threshold or when an estimated emissions savings satisfies predefined criteria.

In one implementation, each of the candidate windows t1, t2, t3, t4 is equal in size to an estimated length (run-time) for the energy consumption task. For example, the carbon emissions intensity predictor 206 may determine the estimated run-time by accessing local or remotely-stored appliance data 234. The appliance data 234 may include, for example, a user profile or an appliance task database usable to look-up or otherwise estimate a run-time for the appliance task identified by the scheduling request 210. In one implementation, the user 204 supplies appliance information to the task scheduling recommendation tool 202 for populating the appliance data 234, such by supplying the make and model of one or more household appliances when initializing the task scheduling recommendation tool 202. In other implementations, the appliance data 234 is estimated based on generalized appliance data, such as average run times, for different types of appliances and appliance tasks.

In addition to task run-time information, the appliance data 234 may also include information such as appliance wattage and/or other power statistics. For example, the user 204 may provide the make and model of one or more appliances during initialization of the task scheduling recommendation tool 202 and the tool may access a third party database (not shown) to retrieve wattage and power information for each appliance.

In one implementation, the carbon emissions intensity predictor 206 identifies the candidate window(s) (e.g., t1, t2, t3, t4) by calculating an amount of carbon emissions savings achieved by executing the energy consumption task within each of multiple time intervals window as compared to carbon emissions expected over an equal-length baseline time interval, such as a baseline interval spanning a peak emissions time or starting at the current time.

To estimate an amount of carbon emissions savings realized by executing the energy consumption task at different times, the carbon emissions intensity predictor 206 may first calculate a total power consumption of the energy consumption task, such as by multiplying an estimated task run-time for the task by an estimated or known wattage of the appliance that is to be performing the task. The carbon emissions intensity predictor 206 may then determine the carbon emissions associated with execution of the task at a set start time by multiplying this estimated power consumption by the net quantity of the predicted emissions 216 associated with a given time window beginning at the start time and having a temporal length approximately equal to the task run-time. The carbon emissions intensity predictor 206 can then estimate an energy savings associated with the start time by comparing the resulting emissions quantity to a like-determined emissions quantity for another time window (e.g., a baseline window such as a window beginning at the current time).

Following identification of the candidate windows (e.g., t1, t2, t3, t4), the user compliance predictor 208 determines a probability of user compliance 224 with a recommendation to initiate the energy consumption task at various times throughout the future time interval. In some implementations, the probability of user compliance 224 is determined for various times spanning the entire future interval (e.g., as shown in FIG. 2) . In other implementations, the probability of user compliance 224 is determined for a smaller subset of times, such as the specific times that coinciding with the start of each one of the identified candidate windows (e.g., t1, t2, t3, and t4).

Inputs to the user compliance predictor 208 may vary in different implementations. In FIG. 2, the user compliance predictor 208 receives global community data 226, such as data that is generally representative of average community preferences. For example, the global community data 226 may indicate a higher likelihood of user compliance with recommendations to execute energy-consumption tasks on weekdays between the hours of 9 to 5 (while most people are at work) than at times outside of these hours. The user compliance predictor 208 may utilize the global community data 226 alone and/or generate the probability of user compliance 224 based on determined user preferences pertaining to appliance task execution. For example, the task scheduling recommendation tool 202 may maintain or have access to a user profile indicating user preferences for the scheduling of different appliances. In one implementation, the user 204 selectively adjusts profile settings to create scheduling rules, such as a rule that prevents the task scheduling recommendation tool 202 from generating recommendations associated with certain hours (such as at night), a rule that ensures tasks are completed by a user-designated “finish time” each day, etc.

A prediction aggregator 232 aggregates and analyzes the predicted emissions 216 and the predicted time-variable probability of user compliance 224 over corresponding interval(s) (collectively represented as aggregated data 236), to select a best one of the identified candidate time windows for the scheduling recommendation 214. The best one of the candidate time windows is selected based on both the predicted emissions 216 and the time-variable probability of user compliance 224 associated with the window.

In one implementation, the task scheduling recommendation tool 202 selects the candidate time window for which the product between the corresponding “estimated emissions savings” and “likelihood of user compliance” is greatest. For example, the task scheduling recommendation tool 202 may determine that of the four candidate windows t1, t2, t3, and t4, the product between a computed estimated emissions savings and likelihood of user compliance is greater for the candidate window t4 than for any other one of the identified candidate windows.

Based on the above and/or other logic weighing both the predicted emissions 216 and the user likelihood of user compliance 224, the task scheduling recommendation tool 202 selects one of the candidate windows and outputs the scheduling recommendation 214 specifying a recommended start time for the energy consumption task that coincides with the start time of the selected candidate window.

In an alternate implementation, the task scheduling recommendation tool 202 does not compute the likelihood of user compliance 224 but instead, applies set rules based on user preferences to select the best candidate window (e.g., such as by eliminating one or more candidates that coincide with times contrary to user preferences).

In the example of FIG. 2, the candidate windows t1, t2, t3, and t4 are initially identified from the predicted emissions 216 (e.g., based on forecasted energy savings) and a best window is selected based on the likelihood of user compliance with recommendation specifying a start time of each one of the candidate windows. In another implementation, the candidate windows (e.g., t1, t2, t3, and t4) are initially identified after the outputs of the prediction modules are combined to form the aggregated data 236. For example, the prediction aggregator 232 may compute the product between an estimated net emissions savings for each of several intervals and the likelihood of user compliance with the recommendation at a start time of each of the several intervals. After computing this product for the several different intervals, the prediction aggregator 232 may identify the interval for which the resulting product is greatest and generate the scheduling recommendation 214 to specify the start time of the identified interval.

In another implementation, the task recommendation scheduling tool 202 uses a metric, such as equation 1 below, to select a recommended start time for the energy consumption task. In equation 1, a computed value (I_{best}) represents a best index for an energy task start time. This index is selected from an array (T_{S}) of potential start times (e.g., where Ts=[tₛ₁, tₛ₂, tₛ₃ . . . tₛₙ]). In this expression, P(C|T=tₛᵢ) represents the conditional probability that the user 204 is to comply with a recommendation to start the task at a time tₛᵢ, where tₛᵢ is a time selected from the array Tₛ. In addition, Pwr(t) represents a power profile of the appliance (e.g., time v. wattage throughout the run time window), which may either be constant (e.g., in the case of a hairdryer) or variable (e.g., a dishwasher). E(t) represents the carbon emission intensity per unit of energy profile (kgCO₂/kWh) of the appliance. The integral of the product between Pwr(t) and E(tₛᵢ+t) is taken over the range from t=0 to t=t_{w} where t_{w} represents a width of the candidate window. For example, t_{w} may be set to equal the predicted task duration (e.g., appliance run time). The expression “argmax” refers to the points in the domain at which the function values are maximized.

$${I}_{best} = {arg max}_{i ∈ 1. . N} ( P ( C \text{\textbar} T = {t}_{si} ) * {\int }_{0}^{{t}_{w}} ( Pwr ( t ) * E ( {t}_{si} * + t ) ) dt )$$

As is apparent to those of skill in the art, a variety of other mathematical techniques may be suitable to utilize the above-described datasets to identify and/or select a recommended start time for initiating the energy consumption task.

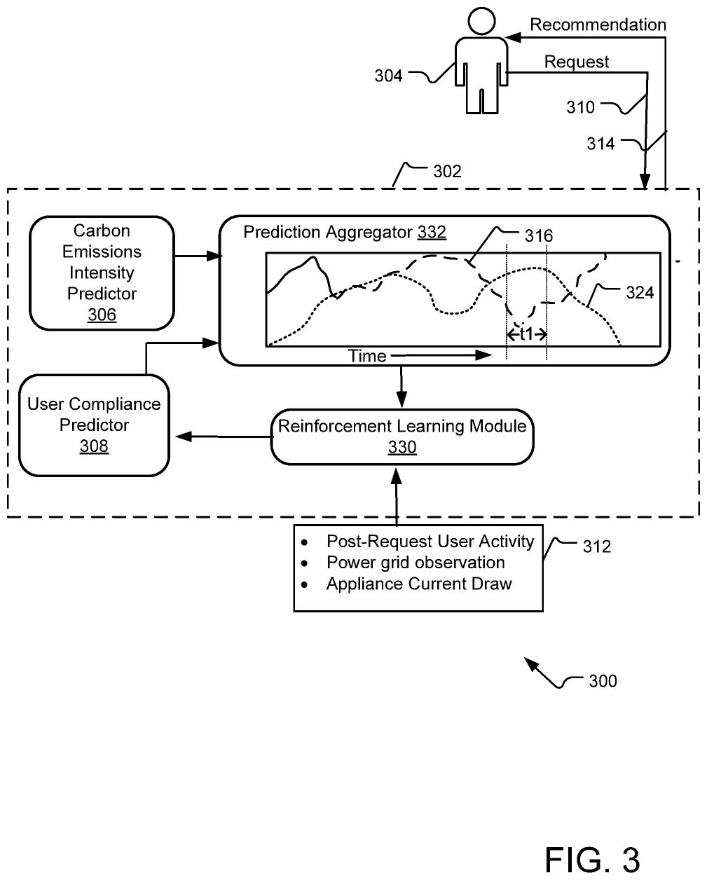

FIG. 3 illustrates another example system 300 that generates recommendations for scheduling energy consumption tasks at times during the day when a local energy grid has a greater dependence on non-renewable resources and when a user is likely to comply with such recommendations. The system 300 includes a task scheduling recommendation tool 302 with several elements similar to those described above with respect to FIG. 1 and/or 2 including, for example, a carbon emissions intensity predictor 306, a user compliance predictor 308, and a prediction aggregator 332.

In response to a request 310 from a user 304 identifying an energy consumption task, the carbon emissions intensity predictor 306 determines predicted emissions 316 (e.g., time-variable carbon emissions from an energy supply grid over a future time interval) and the user compliance predictor 308 determines the likelihood of user compliance 324 for a plurality of times within the future time interval. Inputs to and logic executed by the carbon emissions intensity predictor 306 and the user compliance predictor 308 may be the same or similar to the carbon emissions intensity predictor 306 and the user compliance predictor 208 of FIG. 2.

Similar to the above-described implementations, the prediction aggregator 332 aggregates the predicted emissions 316 and the predicted likelihood of user compliance 324, and the task scheduling recommendation tool 302 outputs a scheduling recommendation 314 based on this aggregated data. In one implementation, the scheduling recommendation 314 specifies a start time for executing the energy consumption task associated with a user request 310. Other details of the task scheduling recommendation tool 302 not explicitly described with respect to FIG. 3 may be the same or similar to those described above with respect to FIGS. 1 and 2.

In addition to those elements shown and described with respect to the system of FIGS. 1 and 2, the task scheduling recommendation tool 302 of FIG. 3 additionally includes a reinforcement learning module 330 that provides feedback to the user compliance predictor 308. The reinforcement learning module 330 collects data to determine whether or not the user 304 actually complied with a recommendation. For example, the task scheduling recommendation tool 302 may output a scheduling recommendation 314 to perform a task at a recommended time (e.g., “1:00 pm is a good time to start the dryer”) and the reinforcement learning module 330 determines, at or after the recommended time, whether or not the task was actually initiated at the recommended time.

In one implementation, the reinforcement learning module 330 uses positive and negative feedback loops to alter prediction parameters of the user compliance predictor 308 and improve the generated user compliance predictions. Over time, this feedback from the reinforcement learning module 330 allows the task scheduling recommendation tool 302 to output more recommendations that the user is likely to comply with.

The reinforcement learning module 330 may determine whether or not a user complied with the scheduling recommendation 314 in a variety of ways, represented collectively in FIG. 3 as feedback inputs 312. In one implementation, the reinforcement learning module 330 analyzes post-request user activity to determine whether or not the user complied with a particular action. If, for example, the task scheduling recommendation tool 306 outputs a recommended task-initiation time of “2 pm,” and the user repeats a request for the same later at a time later than 2 pm the same afternoon, this may indicate that the user did not comply with the recommendation to initiate the task at 2 pm. In this sense, the user's behavior may be inferred based on request patterns (e.g., prompting the task scheduling recommendation tool with the same request multiple times verses no additional times within a defined period).

In yet still another implementation, the reinforcement learning module 330 assesses user compliance with the scheduling recommendation 314 based on user feedback responsive to the scheduling recommendation 314. For example, the user may provide input to confirm compliance or non-compliance with the recommendation (e.g., the user may provide voice input such as: “no, I started the dryer at 4 pm instead of the recommended time of 12 pm”).

In another implementation, the reinforcement learning module 330 determines whether or not a user complied with the scheduling recommendation 314 by retrieving measurements of the current drawn by one or more household appliances at different times of day. For example, the reinforcement learning module 330 may be capable of communicating with processing electronics integrated within a smart sensor, such as a clamp meter, physically attached to a power cord of the appliance. The clamp meter may, for example, include a hall effect sensor that senses and measure the magnetic field caused by current flow, facilitating a measurement of current flowing to the appliance. By monitoring the current drawn by an appliance at different times of day, the reinforcement learning module 330 can then identify spikes in the appliance's power utilization corresponding to the times of day when the appliance is active.

In one implementation, the user 304 can optionally configure the task scheduling recommendation tool 302 to communicate with smart sensors including the above-described current sensing functionality. In this manner, the reinforcement learning module 330 may be able to train and improve modeling of the user compliance predictor 308 and better determine when the user 304 is and is not likely to implement energy saving recommendations.

In still another implementation, the reinforcement learning module 130 determines whether or not the user complied with the scheduling recommendation 114 by analyzing changes in a source load measured at a localized node on a power grid. For example, some neighborhoods may have smart transformers capable of distributing and/or measuring power flows to small groups of residences. By accessing such data, the reinforcement learning module 130 can identify spikes in a source load and infer whether an energy consumption task was executed at a recommended time.

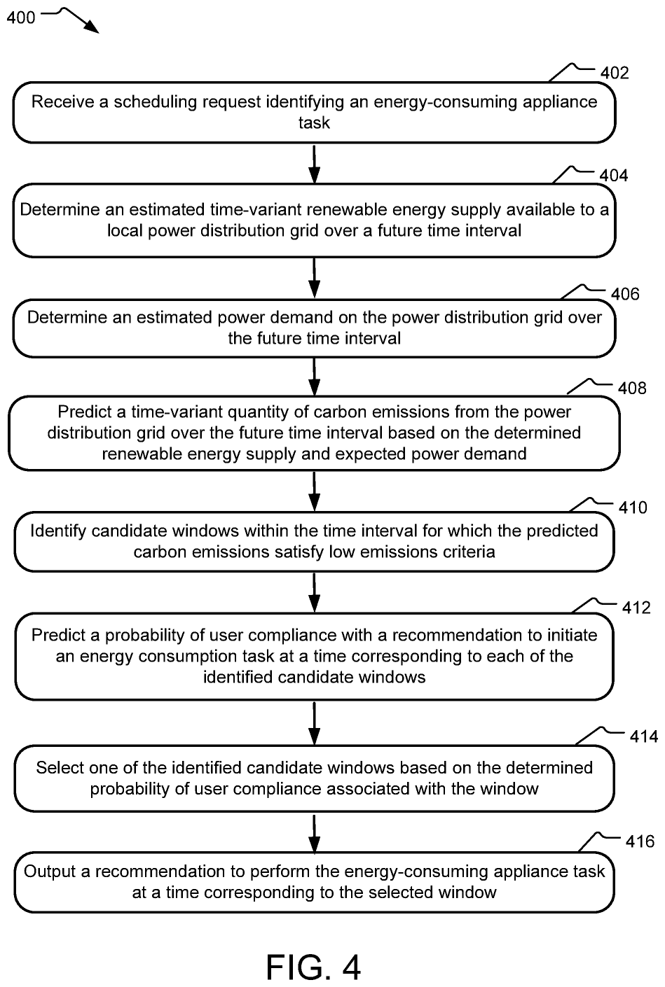

FIG. 4 illustrates example operations 400 for rendering a scheduling task recommendation to reduce carbon emissions that a user is likely to adopt. A receiving operation 402 receives a scheduling request identifying an energy-consuming appliance task.

Responsive to receipt of the request, a determining operation 404 determines an estimated time-variant supply of the renewable energy available to a local power distribution grid over a future time interval. Another determining operation 406 determines an estimated time-variant demand on the power distribution gird over the future time interval. For example, the demand on the power distribution grid may be estimated based on historical demand data, such as power demand data for the power distribution grid that was taken on a same day of year and/or time period as the future time interval.

A prediction operation 408 obtains or generates a prediction of a time-variant quantity of carbon emissions (estimated emissions) generated by the power distribution grid over the future time interval. The estimated emissions is, in one implementation, based on the estimated renewable energy supply determined by the determination operation 404 and on the estimated energy demand determined by the determination operation 406.

An identification operation 410 identifies one or more candidate window (subintervals) within the future time interval for which the predicted carbon emissions satisfy predefined low emissions criteria. For example, the identified low-emissions windows represent times when the predicted carbon emissions resulting from execution of the energy consumption task are minimized or lower than a set threshold or when a predicted emissions savings associated with the window is higher than a threshold. For example, the predicted emissions savings may be a computed carbon emissions savings attributable to execution of the task during a particular window as compared to a baseline window, such as a window beginning at the current time.

Another prediction operation 412 predicts a time-variant probability of user compliance with a recommendation to initiate an energy consumption task at a time corresponding to each of the identified candidate windows. For example, the prediction operation 412 may determine that the user is 20% likely to comply with a recommendation to start the dishwasher at 5 pm but 85% likely to comply with a recommendation to start the dishwasher at 2:30 pm.

A selection operation 414 selects one of the candidate windows identified by the identification operation 410 based on the predicted likelihood of user compliance with a recommendation to initiate the energy consumption task during the window. In one implementation, the selection operation 414 computes a metric for each of the identified candidate windows and selects the candidate window for which the resulting metric is maximized (or minimized, depending on the metric employed). In one implementation, computing the metric for each candidate window includes multiplying the predicted carbon emissions savings for the candidate window by the predicted likelihood of user compliance determined for a start time of the window.

A recommendation operation 416 outputs a recommendation to the user. The recommendation identifies a start time of the candidate window selected by the selection operation 414.

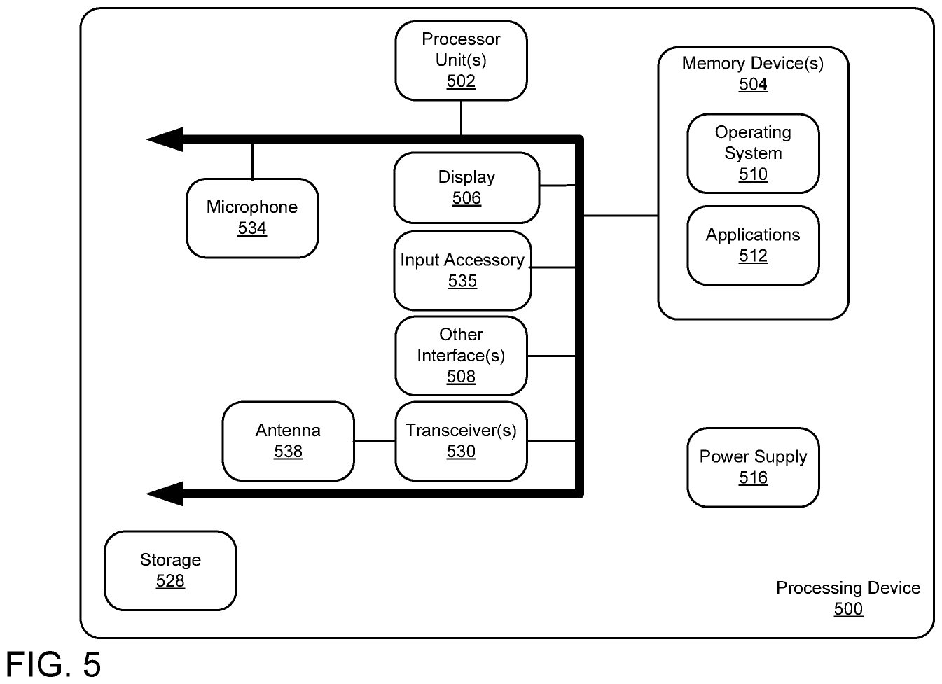

FIG. 5 illustrates an example schematic of a processing device 500 suitable for implementing aspects of the disclosed technology. The processing device 500 includes one or more processor unit(s) 502, memory 504, a display 506, and other interfaces 508 (e.g., buttons). The memory 504 generally includes both volatile memory (e.g., RAM) and non-volatile memory (e.g., flash memory). An operating system 510, such as the Microsoft Windows® operating system, the Microsoft Windows® Phone operating system or a specific operating system designed for a gaming device, resides in the memory 504 and is executed by the processor unit(s) 502, although it should be understood that other operating systems may be employed.

One or more applications 512, such as the task scheduling recommendation tool 106 of FIG. 1, are loaded in the memory 504 and executed on the operating system 510 by the processor unit(s) 502. Applications 512 may receive input from various input local devices such as a microphone 534, input accessory 535 (e.g., keypad, mouse, stylus, touchpad, gamepad, racing wheel, joystick). Additionally, the applications 512 may receive input from one or more remote devices, such as remotely-located smart devices, by communicating with such devices over a wired or wireless network using more communication transceivers 530 and an antenna 538 to provide network connectivity (e.g., a mobile phone network, Wi-Fi®, Bluetooth®). The processing device 500 may also include various other components, such as a positioning system (e.g., a global positioning satellite transceiver), one or more accelerometers, one or more cameras, an audio interface (e.g., the microphone 534, an audio amplifier and speaker and/or audio jack), and storage devices 528. Other configurations may also be employed.

The processing device 500 further includes a power supply 516, which is powered by one or more batteries or other power sources and which provides power to other components of the processing device 500. The power supply 516 may also be connected to an external power source (not shown) that overrides or recharges the built-in batteries or other power sources. In an example implementation, a task-scheduling recommendation tool may include hardware and/or software embodied by instructions stored in the memory 504 and/or the storage devices 528 and processed by the processor unit(s) 502. The memory 504 may be the memory of a host device or of an accessory that couples to the host.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

[[Below I′ve included the claims in prose form. This is a stylistic requirement & there is no need to review provided you are ok with the claims at the end of this document]]. An example method disclosed herein includes determining an estimated time-variant quantity of carbon emissions released from an energy supply plant over a future time interval; predicting a probability of user compliance with a recommendation to initiate an energy consumption task at one or more times within the future time interval; selecting a recommended start time for the energy consumption task based on both the predicted time-variant quantity of carbon emissions and the predicted probability of user compliance with the recommendation at the recommended start time; and outputting the recommended start time for the energy consumption task.

Another example method of any preceding method further comprises computing a net quantity of carbon emissions from the energy supply plant associated with each of multiple candidate windows within the future time interval; identifying a subset of the multiple candidate windows for which the computed net quantity of the carbon emissions satisfies low emissions criteria; and predicting the probability of user compliance with the recommendation at a time corresponding to a start of each of the candidate windows in the identified subset.

In still another example method of any preceding method, the method further comprises computing, for each of the candidate windows, a metric based on the computed net quantity of carbon emissions associated with the candidate window and the predicted probability of user compliance with the recommendation at a start time of the candidate window, selecting a best candidate window based on the computed metric for each of the candidate windows, and outputting a start time of the best candidate window as the recommended start time.

In yet another example method of any preceding method, the method further comprises estimating a carbon emissions savings from the energy supply plant associated with execution of the energy consumption task within each of multiple candidate windows of the future time interval as compared to execution of the energy consumption task during a baseline window and identifying a subset of the multiple candidate windows for which the estimated carbon emissions savings satisfies low emissions criteria. The method further comprises predicting the probability of user compliance with the recommendation at a time corresponding to each candidate window in the identified subset.

In yet another example method of any preceding method, outputting the recommended start time further comprises notifying a user of the recommended start time.

In still another example method of any preceding method, outputting the recommended start time further comprises providing the recommended start time to a smart appliance configured to execute the energy consumption task.

In yet another example method of any preceding method, the method further comprises determining whether the energy consumption task was initiated at the recommended start time; providing positive feedback to a user compliance predictor responsive to determining that the energy consumption task was initiated at the recommended start time; and providing negative feedback to the user compliance predictor responsive to determining that the energy consumption task was not initiated at the recommended start time.

In still another example method of any preceding method, the method further comprises altering a parameter used by the user compliance predictor in selecting the recommended start time responsive to receipt of the negative feedback.

An example system discloses herein includes memory and a task scheduling recommendation tool stored in the memory, the task scheduling recommendation tool being executable to: determine an estimated time-variant quantity of carbon emissions released from an energy supply plant over a future time interval; predict a probability of user compliance with a recommendation to initiate an energy consumption task at one or more times within the future time interval; select a recommended start time for the energy consumption task based on both the predicted time-variant quantity of carbon emissions and the predicted probability of user compliance with the recommendation at the recommended start time; and output the recommended start time for the energy consumption task.

In another example system of any preceding system, the task scheduling recommendation tool is further executable to compute a net quantity of carbon emissions from the energy supply plant associated with each of multiple candidate windows within the future time interval; identify a subset of the multiple candidate windows for which the computed net quantity of the carbon emissions satisfies low emissions criteria; and predict the probability of user compliance with the recommendation at a start time of each of the candidate windows in the identified subset.

An example system disclosed herein includes a means for determining an estimated time-variant quantity of carbon emissions released from an energy supply plant over a future time interval; a means for predicting a probability of user compliance with a recommendation to initiate an energy consumption task at one or more times within the future time interval; a means for selecting a recommended start time for the energy consumption task based on both the predicted time-variant quantity of carbon emissions and the predicted probability of user compliance with the recommendation at the recommended start time; and a means for outputting the recommended start time for the energy consumption task.

In still another example system of any preceding system, the task scheduling recommendation tool is executable to compute a metric for each of the candidate windows of the identified subset The metric is based on the computed net quantity of carbon emissions associated with the candidate window and the predicted probability of user compliance with the recommendation at a start time of the candidate window. The task scheduling recommendation tool is further executable to select a best candidate window based on the computed metric for each of the candidate windows and output a start time of the best candidate window as the recommended start time.

In yet another example system of any preceding system, the task scheduling recommendation tool is further executable to estimate a carbon emissions savings from the energy supply plant associated with each of multiple candidate windows of the future time interval as compared to execution of the energy consumption task during a baseline window; identify a subset of the multiple candidate windows for which the estimated carbon emissions savings satisfies low emissions criteria; and predict the probability of user compliance with the recommendation at a time corresponding to each candidate window in the identified subset.

In still another example system of any preceding system, the task scheduling recommendation tool outputs the recommended start time by notifying a user of the recommended start time.

In yet another example system of any preceding system, the task scheduling recommendation tool outputs the recommended start time by providing the recommended start time to a smart appliance configured to execute the energy consumption task.

In still another example system of any preceding system, the task scheduling recommendation tool further includes a reinforcement learning module stored in memory that is executable to determine whether the energy consumption task was initiated at the recommended start time; provide positive feedback to a user compliance predictor responsive to determining that the energy consumption task was initiated at the recommended start time; and provide negative feedback to the user compliance predictor responsive to determining that the energy consumption task was not initiated at the recommended start time.

In yet still another example system of any preceding system, the reinforcement learning module is executable to alter a parameter used by the user compliance predictor in selecting the recommended start time responsive to receipt of the negative feedback.

In still another example system of any preceding system, the task recommendation scheduling tool determines whether the energy consumption task was initiated at the recommended start time by measuring changes in a source load at a node on a power grid.

One or more example memory devices disclosed herein encode computer-executable instructions for executing a computer process comprising: determining an estimated time-variant quantity of carbon emissions released from an energy supply plant over a future time interval; predicting a probability of user compliance with a recommendation to initiate an energy consumption task at one or more times within the future time interval; selecting a recommended start time for the energy consumption task based on both the predicted time-variant quantity of carbon emissions and the predicted probability of user compliance with the recommendation at the recommended start time; and outputting the recommended start time for the energy consumption task.

In another example memory device of any preceding memory device, the encoded computer process further comprises: computing a net quantity of carbon emissions from the energy supply plant associated with each of multiple candidate windows within the future time interval; identifying a subset of the multiple candidate windows for which the computed net quantity of the carbon emissions satisfies low emissions criteria; and predicting the probability of user compliance with the recommendation at a time corresponding to a start of each of the candidate windows in the identified subset.

In still another example memory device of any preceding memory device, the encoded computer process further comprises: computing, a metric for each of the candidate windows of the identified subset. The metric is based on the computed net quantity of carbon emissions associated with the candidate window and the predicted probability of user compliance with the recommendation at a start time of the candidate window, and the encoded computer process further comprises selecting a best candidate window based on the computed metric for each of the candidate windows; and outputting a start time of the best candidate window as the recommended start time.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method comprising:
determining an estimated time-variant quantity of carbon emissions released from an energy supply plant over a future time interval;
predicting a probability of user compliance with a recommendation to initiate an energy consumption task at one or more times within the future time interval;
selecting a recommended start time for the energy consumption task based on both the predicted time-variant quantity of carbon emissions and the predicted probability of user compliance with the recommendation at the recommended start time; and
outputting the recommended start time for the energy consumption task.

2. The method of claim 1, further comprising:
computing a net quantity of carbon emissions from the energy supply plant associated with each of multiple candidate windows within the future time interval;
identifying a subset of the multiple candidate windows for which the computed net quantity of the carbon emissions satisfies low emissions criteria; and
predicting the probability of user compliance with the recommendation at a time corresponding to a start of each of the candidate windows in the identified subset.

3. The method of claim 2, further comprising:
for each of the candidate windows of the identified subset, computing a metric based on the computed net quantity of carbon emissions associated with the candidate window and the predicted probability of user compliance with the recommendation at a start time of the candidate window;
selecting a best candidate window based on the computed metric for each of the candidate windows; and
outputting a start time of the best candidate window as the recommended start time.

4. The method of claim 1, further comprising:
estimating a carbon emissions savings from the energy supply plant associated with execution of the energy consumption task within each of multiple candidate windows of the future time interval as compared to execution of the energy consumption task during a baseline window;
identifying a subset of the multiple candidate windows for which the estimated carbon emissions savings satisfies low emissions criteria; and
predicting the probability of user compliance with the recommendation at a time corresponding to each candidate window in the identified subset.

5. The method of claim 1, wherein outputting the recommended start time further comprises:
notifying a user of the recommended start time.

6. The method of claim 1, wherein outputting the recommended start time further comprises:
providing the recommended start time to a smart appliance configured to execute the energy consumption task.

7. The method of claim 1, further comprising:
determining whether the energy consumption task was initiated at the recommended start time;
providing positive feedback to a user compliance predictor responsive to determining that the energy consumption task was initiated at the recommended start time; and
providing negative feedback to the user compliance predictor responsive to determining that the energy consumption task was not initiated at the recommended start time.

8. The method of claim 7, further comprising:
altering a parameter used by the user compliance predictor in selecting the recommended start time responsive to receipt of the negative feedback.

9. A system comprising:
memory; and
a task scheduling recommendation tool stored in the memory and executable to:
determine an estimated time-variant quantity of carbon emissions released from an energy supply plant over a future time interval;
predict a probability of user compliance with a recommendation to initiate an energy consumption task at one or more times within the future time interval;
select a recommended start time for the energy consumption task based on both the predicted time-variant quantity of carbon emissions and the predicted probability of user compliance with the recommendation at the recommended start time; and
output the recommended start time for the energy consumption task.

10. The system of claim 9, wherein the task scheduling recommendation tool is further executable to:
compute a net quantity of carbon emissions from the energy supply plant associated with each of multiple candidate windows within the future time interval;
identify a subset of the multiple candidate windows for which the computed net quantity of the carbon emissions satisfies low emissions criteria; and
predict the probability of user compliance with the recommendation at a start time of each of the candidate windows in the identified subset.

11. The system of claim 10, wherein the task scheduling recommendation tool is further executable to:
compute a metric for each of the candidate windows of the identified subset, the metric based on the computed net quantity of carbon emissions associated with the candidate window and the predicted probability of user compliance with the recommendation at a start time of the candidate window;
select a best candidate window based on the computed metric for each of the candidate windows; and
output a start time of the best candidate window as the recommended start time.

12. The system of claim 9, wherein the task scheduling recommendation tool is further executable to:
estimate a carbon emissions savings from the energy supply plant associated with each of multiple candidate windows of the future time interval as compared to execution of the energy consumption task during a baseline window;
identify a subset of the multiple candidate windows for which the estimated carbon emissions savings satisfies low emissions criteria; and
predict the probability of user compliance with the recommendation at a time corresponding to each candidate window in the identified subset.

13. The system of claim 9, wherein the task scheduling recommendation tool outputs the recommended start time by:
notifying a user of the recommended start time.

14. The system of claim 9, wherein task scheduling recommendation tool outputs the recommended start time by:
providing the recommended start time to a smart appliance configured to execute the energy consumption task.

15. The system of claim 9, wherein the task scheduling recommendation tool further includes a reinforcement learning module stored in memory and executable to:
determine whether the energy consumption task was initiated at the recommended start time;
provide positive feedback to a user compliance predictor responsive to determining that the energy consumption task was initiated at the recommended start time; and
provide negative feedback to the user compliance predictor responsive to determining that the energy consumption task was not initiated at the recommended start time.

16. The system of claim 15, wherein the reinforcement learning module is executable to alter a parameter used by the user compliance predictor in selecting the recommended start time responsive to receipt of the negative feedback.

17. The system of claim 12, wherein the task recommendation scheduling tool determines whether the energy consumption task was initiated at the recommended start time by measuring changes in a source load at a node on a power grid.

18. One or more memory devices encoding computer-executable instructions for executing a computer process comprising:
determining an estimated time-variant quantity of carbon emissions released from an energy supply plant over a future time interval;
predicting a probability of user compliance with a recommendation to initiate an energy consumption task at one or more times within the future time interval;
selecting a recommended start time for the energy consumption task based on both the predicted time-variant quantity of carbon emissions and the predicted probability of user compliance with the recommendation at the recommended start time; and
outputting the recommended start time for the energy consumption task.

19. The one or more memory devices of claim 18, wherein the computer process further comprises:
computing a net quantity of carbon emissions from the energy supply plant associated with each of multiple candidate windows within the future time interval;
identifying a subset of the multiple candidate windows for which the computed net quantity of the carbon emissions satisfies low emissions criteria; and
predicting the probability of user compliance with the recommendation at a time corresponding to a start of each of the candidate windows in the identified subset.

20. The one or more memory devices of claim 19, wherein the computer process further comprises:
for each of the candidate windows of the identified subset, computing a metric based on the computed net quantity of carbon emissions associated with the candidate window and the predicted probability of user compliance with the recommendation at a start time of the candidate window;
selecting a best candidate window based on the computed metric for each of the candidate windows; and
outputting a start time of the best candidate window as the recommended start time.
